(19) United States
(12) Patent Application Publication
(10) Pub. No.: US 2003/0124366 A1
(43) Pub. Date: Jul. 3, 2003

(54) Process for reducing or eliminating antigenic protein in liquid latex

(76) Inventors: George H. Carroll, Ventura, CA (US); Arthur A. Krause, Winnetka, CA (US)

Correspondence Address: DENNIS H. LAMBERT & ASSOCIATES, 7000 VIEW PARK DRIVE, BURKE, VA, 22015, US

(21) Appl. No.: 10/301,541

(22) Filed: Nov. 21, 2002

Related U.S. Application Data
(60) Provisional application No. 60/331,774, filed on Nov. 21, 2001.

(51) Int. Cl. B32B 27/06

(52) U.S. Cl. 428/480

(57) ABSTRACT

A process for treating raw liquid latex to destroy antigenic protein in the latex without causing undesirable alterations of physical characteristics of the liquid latex, whereby articles made from the treated liquid latex do not produce an adverse reaction in persons sensitive to the antigenic protein. A preferred process according to the invention utilizes pasteurization equipment and procedures, wherein cold raw liquid latex is supplied to a pasteurization apparatus to heat the raw liquid latex to a pasteurization temperature of from about 140° F. to about 210° F., hold the heated latex at the pasteurization temperature for a predetermined period of time sufficient to destroy antigenic protein in the latex, and then cool the pasteurized liquid latex for subsequent handling. In one embodiment of the invention, the process uses a batch pasteurizer, and in the preferred embodiment uses a continuous plate pasteurizer.

This application claims the benefit of U.S. provisional patent application Ser. No. 60/331,774, filed Nov. 21, 2001.

### BACKGROUND OF THE INVENTION

1. Field of the Invention

This invention relates generally to an improved natural rubber latex for use in articles intended to be placed in contact with the human body. More specifically, the invention relates to a process for treating raw natural rubber latex to reduce or eliminate the antigenic protein contained therein.

2. Prior Art

Many articles made from hydrocarbon elastomers, such as natural rubber latex, have long been in use. These articles include medical devices such as gloves, condoms, intrauterine contraceptive devices, endoscopic tubes, and the like. Infant pacifiers and bottle nipples, crib liners and other articles are also commonly made from natural rubber latex. Although there have been instances of adverse reactions to these latex articles, the relatively small number of instances has not previously generated a significant public health concern.

However, during the past decade or two there has been an enormous increase in use of latex gloves, due at least partially to awareness of AIDS and associated public health issues, particularly the need for protection of health care workers. A revision of OSHA regulations in 1992 also contributed to the increase in use of latex gloves. This increase in exposure to latex gloves by health care workers has accelerated the number of latex reactions. It is estimated that as many as twenty five percent (25%) of health care workers experience some type of reaction to latex products.

Natural rubber (cis-1,4-polyisoprene) is derived from liquid latex collected from the Hevea brasiliensis tree. This liquid latex contains a variety of cellular enzymes, proteins, and nucleic acids. Many of the latex proteins retain their allergenicity after the vulcanization process and are clinically significant contaminants in finished goods.

Latex sensitivity to products containing natural rubber latex can be either an irritant reaction or an allergic reaction. Irritant reactions are common and are often the result of prolonged irritation from maceration (perspiring) while wearing gloves, for example. Allergic reactions may be either a type IV reaction, which is more common and is a delayed reaction to the processing chemicals used in the manufacturing process, or a type I reaction, which is less common but is more severe. Type I reactions result from reaction to the latex proteins found in all natural rubber latex products. Reactions range from urticaria (hives), swelling of the lips, nasal congestion, and respiratory problems, to a life-threatening anaphylactic reaction. Reactions to latex can be caused by direct contact or through airborne contact. For example, latex protein particles can be aerosolized and dispersed by the donning powders used in medical gloves.

Although there is no known concentration of latex protein that would be considered safe for the extremely sensitive patient, it is important that gloves and other medical devices be manufactured with minimal levels of contaminating latex allergen. The Food and Drug Administration has proposed changing the way that natural rubber latex products are labeled, so that they would carry a warning, similar to that found on tobacco products.

The industry, particularly manufacturers of latex gloves, has responded to the problem in a variety of ways. Efforts have been made by manufacturers to produce latex gloves with reduced levels of protein content and to reduce the content of the processing chemicals. For instance, enzymes have been used by some with limited success in an effort to kill or destroy the protein. Unfortunately, this treatment process also has undesirable effects on other physical properties.

Some gloves are washed with a dilute solution of hydrochloric acid (HCL) and water to sterilize the gloves. This also has the effect of reducing the protein concentration in the gloves, but turns the gloves tan or brown in color and also has a deleterious effect on other physical properties. Gloves treated in this way are therefore less desirable, and merely reducing the level of protein or chemicals does not help those people who are particularly sensitive and reactive to any level of the allergens.

It has been a common misperception that the donning powder used in gloves is the allergen that caused the reaction, and many companies have introduced powder-free gloves. While some people may be allergic to the cornstarch or other additive that is used as the donning agent, in most instances the powder has been determined to be a transfer agent for the latex protein, which may bond with the powder particles and be dispersed into the air where patient contact can occur. Nonetheless, powder-free gloves do reduce the likelihood of an airborne transfer of the latex protein allergen.

It has been proposed to subject latex gloves to fluorination in order to alter the surface characteristics (i.e., fluorine atoms replace hydrogen atoms in the carbon spine) and improve the lubricity of the glove, whereby it would not be necessary to use a donning powder. See U.S. Pat. No. 3,992,221 to Homsy, et al. This proposal goes a long way toward eliminating the problem associated with airborne particles of donning powder and latex protein that might be carried with it, but there is no suggestion or recognition in this patent of reducing or eliminating the antigenic latex protein in the gloves. Moreover, the treatment process disclosed in this patent is carried out at a relatively high temperature (at least 104° F.) and concentration of fluorine gas (up to 5:1 parts fluorine to parts inert gas), and is carried out over a relatively long period of time (e.g., more than 15 minutes dwell time after the gas mixture is introduced into the glove).

Further, individual gloves are inflated with the gas mixture while the glove is on the forming mandrel so that the glove is extended by at least 10%.

Plastic articles have been fluorinated in the prior art to improve their surface characteristics for printing, and to densify the material to inhibit gassing off or evaporation of volatile compounds from the contents of plastic containers, but the concentration of fluorine used in these procedures is typically 100%, at a temperature of more than 100° F., with a time of exposure to the gas of as much as three hours.

Fluorination treatment of latex articles in the prior art is not done to eliminate or reduce the antigenic latex protein in the article so that is safe for contact with persons sensitive to the protein. This benefit of fluorination has not been recognized in the prior art. Instead, as noted above, latex articles have been fluorinated for entirely different purposes, e.g., to improve the lubricity of medical gloves to facilitate donning them, whereby donning powders could be omitted.

Further, as noted above, prior art fluorination treatment of latex and plastic articles is typically carried out at much higher concentrations of fluorine, e.g., up to 100%, and at elevated temperatures and pressures, e.g., 125° F. to 132° F., and 100 psi or more, for much longer periods of time, e.g., 35 minutes to 3 hours. Treatment of latex gloves and/or condoms, in particular, at these conditions would be entirely unsuitable because of the deleterious alteration of physical properties such as strength, flexibility and color. Moreover, articles treated in accordance with these prior art processes must generally be subjected to further treatments, such as washing, before they can be used. As a consequence, these processes and the articles produced thereby are relatively expensive. Moreover, latex articles such as gloves and condoms fluorinated in accordance with these parameters would be unsuitable for use because of the change in color and reduction in strength and flexibility that would result.

Other manufacturers have introduced non-latex products in order to avoid the problem of allergic reactions to the latex proteins. For instance, some manufacturers have used vinyl to make gloves for medical and other uses, but the vinyl is not as flexible or comfortable as latex and these gloves therefore are not entirely satisfactory, especially for surgical use. Still other gloves have been made of nitrile, but these gloves are thicker than latex gloves, have a different feel, and tend to have a loose fit. Gloves made of vinyl or nitrile are therefore typically used for examination gloves.

In spite of the industry's efforts, no one has yet developed a process for treating a latex article to reduce or eliminate the antigenic latex protein present in the article while at the same time retaining all other desirable physical properties of the article.

In their copending application, Ser. No. 10/042,817, filed Oct. 29, 2001, applicants have proposed a novel treatment of latex articles, and especially latex gloves, wherein the gloves, following manufacture, are contacted with a gaseous mixture containing a reactive gas such as fluorine to significantly reduce the concentration of latex protein in the gloves to a level that is not reactive to persons sensitive to the latex protein, and wherein the gloves retain their desirable physical properties, such as color, strength and flexibility.

Applicants have now improved the treatment process described in their earlier application so that it is highly efficient and economical, and far superior to conventional and previous processes.

### SUMMARY OF THE INVENTION

In accordance with the present invention, applicants have discovered that by treating raw natural liquid latex they can eliminate or reduce the level of antigenic protein in the latex so that articles subsequently manufactured from the latex do not cause an adverse reaction in persons sensitive to the protein.

By heating the liquid latex at the appropriate temperature for an appropriate period of time, the antigenic proteins in the liquid latex are destroyed. In particular, applicants have discovered that by heating the liquid latex to a temperature of from about 140° F. to about 210° F. the antigenic protein is destroyed. Pasteurization processes, e.g., batch or continuous, could be used. These processes are commonly used to pasteurize milk, for example.

Batch pasteurization uses a vat pasteurizer comprising a jacketed vat surrounded by either circulating water, steam or heating coils of water or steam. In the vat, the material to be pasteurized is heated and held throughout the holding period while being agitated. The material may be cooled in the vat or removed hot after the holding time is completed. As a modification, the material may be partially heated in a tubular or plate heater before entering the vat.

The continuous process has several advantages over the vat method, the most important being time and energy saving. For most continuous processing, a high temperature short time (HTST) pasteurizer is used. The heat treatment is accomplished using a plate heat exchanger. This piece of equipment comprises a stack of corrugated stainless steel plates clamped together in a frame. There are several flow patterns that can be used. Gaskets are used to define the boundaries of the channels and to prevent leakage. The heating medium can be vacuum steam or hot water.

The basic components of the HTST pasteurizer comprise a balance tank or constant level tank for holding raw liquid latex, a float valve assembly in the tank that controls the liquid level nearly constant, ensuring a uniform head pressure on the liquid latex leaving the tank and that provides a constant supply of raw liquid latex. A raw latex regenerator is connected to receive raw liquid latex from the balance tank, and utilizes the heat content of pasteurized latex to warm incoming cold raw latex. A positive displacement timing pump draws product through the raw product regenerator and pushes the product under pressure through a heater and then through a holding tube, controller sensor, flow diversion device, pasteurized product regenerator, and cooler. The timing pump also governs the rate of flow of product through the holding tube, which primarily serves to determine the dwell time of the product at pasteurization temperature.

As an example, cold raw liquid latex at about 40° F. in the constant level tank is drawn into the raw product regenerator section of the pasteurizer, where the latex is warmed to approximately 135° F. to 154° F. by heat given up by hot pasteurized latex flowing in a counter current direction on the opposite side of the thin, stainless steel plates. The raw liquid latex, still under suction, passes through the positive displacement timing pump which delivers it under positive pressure through the rest of the HTST system, as described above.

The raw latex is forced through the heater section where hot water on opposite sides of the plates heat the latex to a temperature of at least about 140° F. The latex, at pasteurization temperature and under pressure, flows through the holding tube where it is held for about 16 seconds. The holding time may be determined by the length of the holding tube and operation of the timing pump. For instance, maximum velocity of the latex through the holding tube is governed by the speed of the timing pump, diameter and length of the holding tube, and surface friction.

After passing temperature sensors of an indicating thermometer and recorder-controller in the controller sensor at the end of the holding tube, the latex passes into the flow diversion device (FDD). The FDD assumes a forward-flow position if the latex passes the recorder-controller at a preset cut-in temperature (greater than about 140° F. and up to about 210° F.). The FDD remains in a normal position which is in diverted-flow if the latex has not achieved the preset cut-in temperature. Inadequately heated latex flows through the diverted flow line of the FDD and back to the raw latex constant level tank. Appropriately heated latex flows through the forward flow part of the FDD to the pasteurized latex regenerator section where it gives up heat to the raw product and in turn is cooled to between approximately 90° F. and 48° F.

Warm latex passes through a cooling section where it is cooled to about 39° F. or below by coolant on the opposite sides of the thin, stainless steel plates. The cold, pasteurized latex passes through a vacuum breaker at least 12 inches above the highest raw latex in the HTST system and then on to a storage tank filler for packaging.

A higher pressure preferably is maintained on the pasteurized side of the heat exchanger than on the unpasteurized side. By keeping the pressure of the pasteurized latex at least 1 psi greater than the pressure of the raw latex in the regenerator, contamination of pasteurized latex with raw latex is prevented in the event a leak should develop in the thin stainless steel plates. In a simple system, the pressure differential is maintained by a timing pump, and in more complex systems it is maintained by differential pressure controllers and back pressure flow regulators at the chilled pasteurization outlet.

The location of the timing pump is crucial, and should be placed so that there is suction on the raw latex regenerator side and positive pressure on the pasteurized latex regenerator side. Other factors involved in maintaining the desired pressure differential are the balance tank overflow level, location of installation of the booster pump, the absence of any pump after the pasteurized latex outlet to the vacuum breaker, the extent of vertical rise to the vacuum breaker, and free drainage from the raw latex regenerator to the balance tank at shut down.

Raw liquid latex processed in accordance with the invention, i.e., in a pasteurization process, is free of any detrimental level of antigenic protein and can be used to manufacture latex articles that can safely come into contact with the human body without causing any adverse reaction. This approach is far more economical and easy to accomplish than treating latex articles after they are manufactured in order to reduce or eliminate the antigenic protein in the articles.

### BRIEF DESCRIPTION OF THE DRAWINGS

The foregoing as well as other objects and advantages of the invention will become apparent from the following detailed description when considered in conjunction with the accompanying drawings, wherein like reference characters designate like parts throughout the several views, and wherein:

FIG. 1 is a schematic diagram of a basic continuous pasteurization system that may be used in practicing the invention.

FIG. 2 is a somewhat schematic sectional view of a balance tank as used in the process of the invention.

FIG. 3 is a schematic sectional side view of a continuous plate pasteurizer heat exchanger suitable for use in practicing the invention.

FIG. 4 is an exploded perspective view of a series of plates as used in the plate heat exchanger.

FIG. 5 is a plan view of a single plate as used in the plate heat exchanger.

FIGS. 6A and 6B are somewhat schematic sectional views of a single stem flow diversion device that could be used in the process of the invention, wherein FIG. 6A shows the device in a flow diverting position and FIG. 6B shows the device in a forward flow position.

FIG. 7 is a somewhat schematic sectional view of a modified flow diversion device, wherein a dual stem approach is utilized.

FIG. 8 is a diagrammatic illustration of the residence time profile of the latex in the HTST pasteurizer of the invention.

FIG. 9 is a schematic drawing of a batch pasteurizer suitable for use in practicing the invention.

### DETAILED DESCRIPTION OF THE PREFERRED EMBODIMENTS

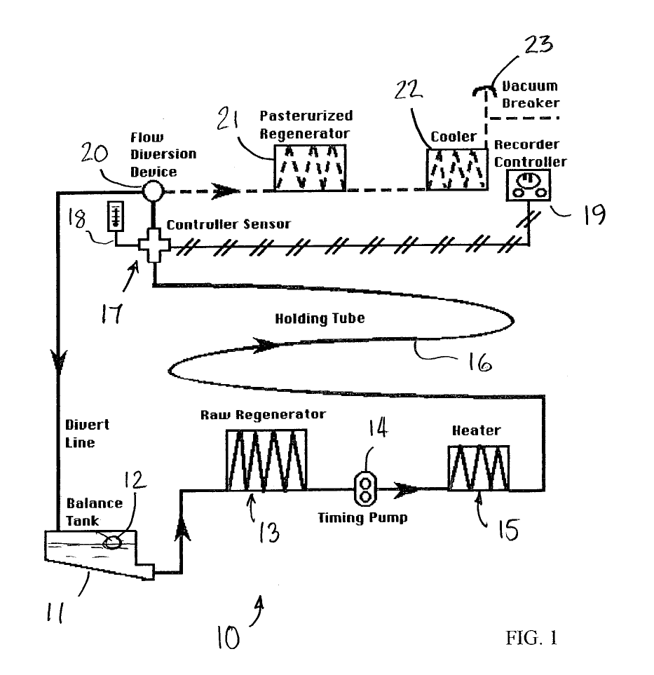

A high temperature short time (HTST) continuous pasteurizer is indicted generally at 10 in FIG. 1. A quantity of raw liquid latex is contained in a balance tank or constant level tank 11, which has a float valve assembly 12 that controls the liquid level nearly constant, ensuring a uniform head pressure on the liquid latex leaving the tank and providing a constant supply of raw liquid latex. A raw latex regenerator 13 is connected to receive raw liquid latex from the balance tank, and as described more fully below, utilizes the heat content of heated pasteurized latex to warm incoming cold raw latex. A positive displacement timing pump 14 draws the raw liquid latex through the regenerator 13 and pushes the product under pressure through a heater 15 and then through a holding tube 16, which terminates at a controller sensor 17. The controller sensor includes an indicating thermometer temperature sensor 18 and a recorder-controller 19. From the controller sensor 17 the latex passes through a flow diversion device (FDD) 20, which either diverts the latex back to the balance tank if the temperature of the latex is not appropriate, or if the temperature is appropriate causes it to flow on to a pasteurized latex regenerator 21. From the pasteurized latex regenerator the pasteurized latex passes through a cooler 22 which cools the latex to between approximately 90° F. and 48° F., and then through a vacuum breaker 23 for subsequent handling and packaging.

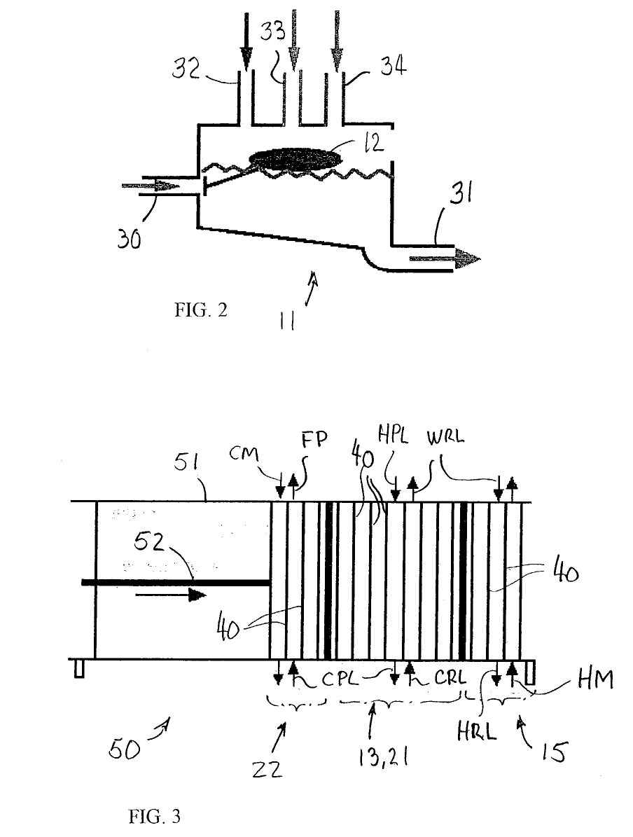

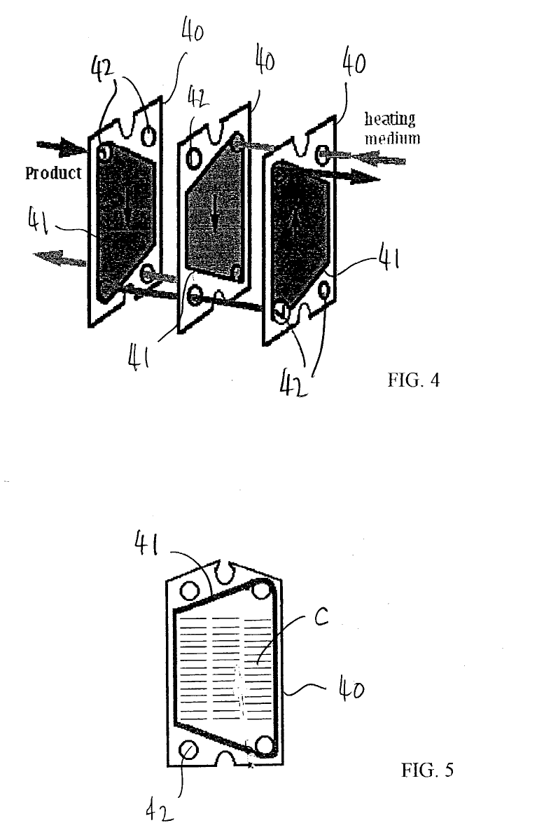

As seen best in FIG. 2, the balance tank 11 has an inlet 30 through which raw liquid latex is supplied to the tank, and an outlet 31 through which the latex is supplied to the rest of the HTST system. Additional inlets 32, 33 and 34 are provided for returning recirculation flow, or leak detector flow, or diverted flow, respectively, to the balance tank for additional processing.

The raw product regenerator section 13 and the pasteurized product regenerator section 21 of the pasteurizer each comprise a plurality of thin, stainless steel plates 40 stacked together and sealed at their confronting faces with suitable gaskets 41 and flow passages 42 arranged to achieve a desired flow pattern through the stacked plates. As depicted in FIG. 5, the plates 40 may be corrugated as at C or otherwise shaped to optimize heat exchange between the materials flowing on opposite sides of the plates. In this regard, flow is arranged so that product to be heated flows on one side of the respective plates, and a heating medium, e.g., hot pasteurized latex, or hot water, depending upon the stage in the process, flows on the opposite side. Thus, in the raw product regenerator, the incoming cold latex is warmed to approximately 135° F. to 154° F. by heat given up by the hot pasteurized latex flowing in a counter current direction on the opposite side of the plates.

FIG. 3 is a schematic representation of a continuous plate pasteurizer 50 that performs the heating function depicted in the diagram of FIG. 1. The pasteurizer comprises a series of thin plates 40 stacked face-to-face in a housing 51 to define the heater 15, regenerator sections 13 and 21, and cooling section 22. The plates may be held in tight abutting relationship with one another by a screw press 52. As depicted in this figure, cold raw liquid latex CRL is supplied to the regenerator section in counter flowing relationship to hot pasteurized latex HPL, resulting in some cooling of the pasteurized latex and some heating of the cold raw latex. The warm raw latex WRL is then caused to flow through the heater section in counter flowing relationship to a heating medium HM, e.g. hot water, to produce hot raw latex HRL. The hot raw latex then flows through the holding tube 16 to produce the hot pasteurized latex HPL, which then flows through the regenerator, resulting in cool pasteurized latex CPL, which then flows through the cooling section in counter flowing relationship to a cooling medium CM, e.g., cold water, to produce cold pasteurized latex or finished product FP.

The timing pump 14 governs the rate of flow of product through the holding tube 16, the length of which primarily serves to determine the dwell time of the product at pasteurization temperature, as described more fully below.

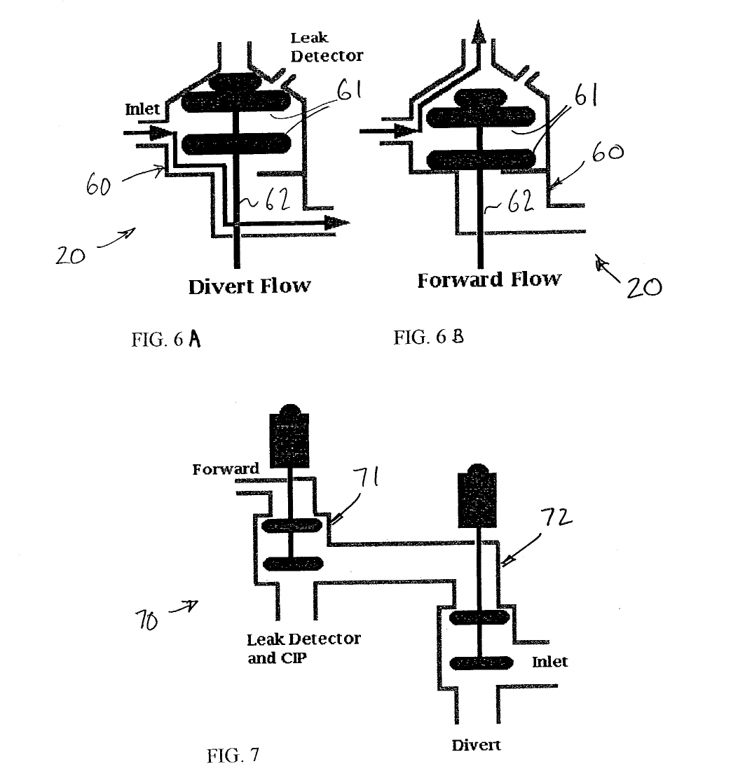

The flow diversion device 20 may be of single stem construction as shown at 60 in FIGS. 6A and 6B. In this form, a double headed valve 61 is carried by a stem 62 for reciprocation from a diverted position as shown in FIG. 6A, to a forward flow position as shown in FIG. 6B. In the diverted position, product that has not been heated sufficiently is diverted back to the balance tank for further processing. In the forward flow position, product that has been heated to the appropriate temperature is permitted to flow on to the cooler 22 and subsequent packaging. The valve is moved between its operative positions by suitable drive means (not shown) actuated in response to the controller sensor 17.

Alternatively, the flow diversion device 20 may comprise a dual stem construction as shown at 70 in FIG. 7. In this form, a pair of double headed valves 71 and 72 are arranged in series to either divert flow back to the balance tank, or permit product to continue forward through the system.

In an example of operation of the system to treat raw liquid latex to destroy the antigenic protein therein, cold raw liquid latex at about 40° F. in the constant level tank 11 is drawn by the pump 14 into the raw product regenerator section 13 of the pasteurizer, where the latex is warmed to approximately 135° F. to 154° F. by heat given up by hot pasteurized latex flowing in a counter current direction on the opposite side of the thin, stainless steel plates. The raw liquid latex, still under suction, passes through the positive displacement timing pump which delivers it under positive pressure through the heater section 15 where hot water on opposite sides of the plates heat the latex to a temperature of at least about 140° F., and up to about 210° F. The latex, at pasteurization temperature and under pressure, flows through the holding tube 16 where it is held for about 16 seconds. The holding time may be determined by the length of the holding tube and operation of the timing pump. For instance, maximum velocity of the latex through the holding tube is governed by the speed of the timing pump, diameter and length of the holding tube, and surface friction.

After passing the temperature sensors of the indicating thermometer 18 and recorder-controller19 in the controller sensor 17 at the end of the holding tube, the latex passes into the flow diversion device (FDD) 20. The FDD assumes a forward-flow position if the latex passes the recorder-controller at a preset cut-in temperature (greater than about 140° F. and up to about 210° F.). The FDD remains in a normal position which is in diverted-flow if the latex has not achieved the preset cut-in temperature. Inadequately heated latex flows through the diverted flow line of the FDD and back to the raw latex constant level tank. Appropriately heated latex flows through the forward flow part of the FDD to the pasteurized latex regenerator section 21 where it gives up heat to the raw product and in turn is cooled to between approximately 90° F. and 48° F.

Warm latex from the pasteurized latex regenerator section passes through the cooling section 22 where it is cooled to about 39° F. or below by coolant on the opposite sides of the thin, stainless steel plates. The cold, pasteurized latex then passes through the vacuum breaker 23, which is at least 12 inches above the highest level of raw latex in the HTST system. From the vacuum breaker, the pasteurized latex is passed on to a storage tank filler (not shown) for packaging, or to other apparatus for desired handling.

A higher pressure preferably is maintained on the pasteurized side of the heat exchanger than on the unpasteurized side. By keeping the pressure of the pasteurized latex at least 1 psi greater than the pressure of the raw latex in the regenerator, contamination of pasteurized latex with raw latex is prevented in the event a leak should develop in the thin stainless steel plates. In a simple system, the pressure differential is maintained by the timing pump, and in more complex systems it is maintained by differential pressure controllers (not shown) and back pressure flow regulators (not shown) at the chilled pasteurization outlet.

The location of the timing pump is crucial, and should be placed so that there is suction on the raw latex regenerator side and positive pressure on the pasteurized latex regenerator side. Other factors involved in maintaining the desired pressure differential are the balance tank overflow level, location of installation of the booster pump, the absence of any pump after the pasteurized latex outlet to the vacuum breaker, the extent of vertical rise to the vacuum breaker, and free drainage from the raw latex regenerator to the balance tank at shut down.

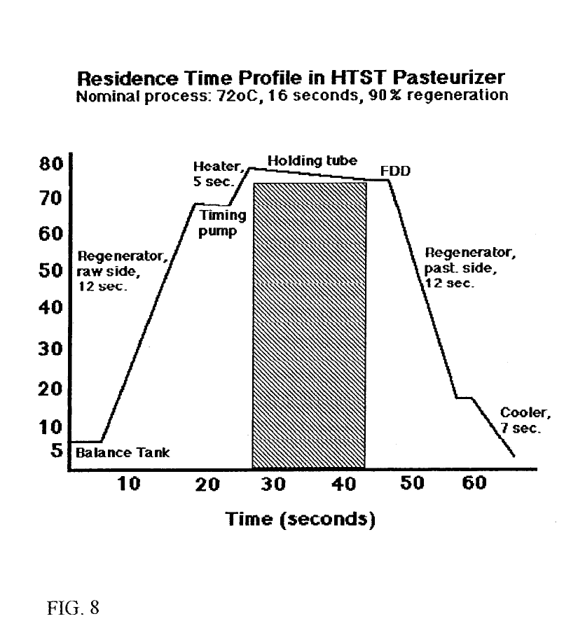

FIG. 8 depicts a typical residence time profile of the latex in the HTST pasteurizer of the invention.

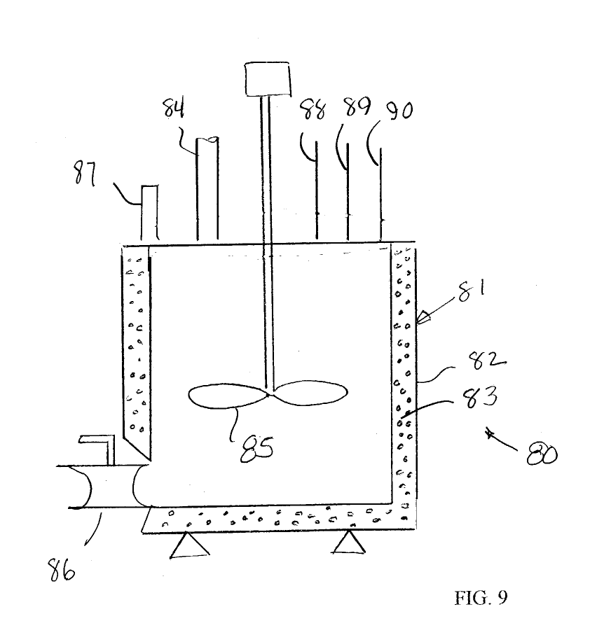

A batch pasteurizer suitable for use in practicing the invention is indicated generally at 80 in FIG. 9. The batch pasteurizer comprises a vat 81 having a jacket 82 through which a heating medium 83 is circulated, and an inlet 84 for introduction of cold raw liquid latex to the vat. An agitator 85 is provided in the vat to agitate the latex as it is heated. After the latex is heated to a predetermined temperature, i.e., between about 140° F. and 210° F., it is held at that temperature while being agitated for a predetermined period of time sufficient to destroy the antigenic protein in the latex. Thereafter, the latex is cooled to about 39° F. for subsequent handling, e.g., packaging. Heated and cooled latex is removed from the vat via a close coupled valve 86. An air space heater 87, recording thermometer 88, air space thermometer 89 and indicating thermometer 90 are also preferably provided in association with a cover (not shown) applied to the vat.

Other systems may be used for heating the raw liquid latex to destroy the antigenic protein therein, but the continuous pasteurization system as described herein is believed to be the most efficient. In any event, the process of the invention, and particularly the treatment of raw liquid latex to destroy antigenic protein in the latex, is believed to be desirable over other processes which rely upon treatment of finished articles manufactured from untreated latex.

Although particular embodiments of the invention are illustrated and described in detail herein, it is to be understood that various changes and modifications may be made to the invention without departing from the spirit and intent of the invention as defined by the scope of the appended claims.

What is claimed is:

1. A process for treating raw liquid latex to destroy antigenic proteins in the latex, whereby the latex may be used to manufacture articles that do not produce an adverse reaction in persons sensitive to antigenic proteins normally present in latex, comprising the steps of:
heating the raw liquid latex to an effective temperature of from about 140° F. to about 210° F. for a limited time sufficient to destroy the antigenic protein but not alter the physical characteristics of the liquid latex.

2. A process as claimed in claim 1, including the steps of:
warming incoming cool raw latex by causing heated latex to flow in counter current relationship therewith in a heat exchanger.

3. A process as claimed in claim 2, including the steps of:
heating the warmed raw latex to said effective temperature, and then cooling the latex to a temperature of about 39° F. for packaging or other handling.

4. A process as claimed in claim 3, including the steps of:
sensing the temperature of the heated latex and diverting back to be reheated any latex that has not achieved said effective temperature.

5. A pasteurization process for treating raw liquid latex to destroy antigenic protein in the latex without causing undesirable alterations of physical characteristics of the liquid latex, whereby articles made from the treated liquid latex do not produce an adverse reaction in persons sensitive to the antigenic protein, comprising the steps of:
supplying raw liquid latex to a pasteurization apparatus to heat the raw liquid latex to a pasteurization temperature sufficient, holding the heated latex at said pasteurization temperature for a predetermined period of time to destroy antigenic protein in the latex, and then cooling the pasteurized liquid latex for subsequent handling.

6. A pasteurization process as claimed in claim 5, wherein:
the pasteurization process is a batch process, wherein the raw liquid latex is supplied to a vat and heated to said pasteurization temperature and held at said pasteurization temperature for a predetermined period of time, while being agitated, to destroy the antigenic protein.

7. A pasteurization process as claimed in claim 5, wherein:
the pasteurization process is a continuous process, wherein cold raw liquid latex is supplied to a constant level balance tank that controls the liquid level nearly constant, ensuring a uniform head pressure on the liquid latex leaving the tank and providing a constant supply of raw liquid latex;
causing the raw liquid latex to flow from the balance tank to a heater where the latex is heated to an elevated temperature;
causing the heated latex to flow through a holding tube where the heated latex is maintained at said elevated temperature for a predetermined time, the step of heating said latex to said elevated temperature and holding it at said elevated temperature for said predetermined time being sufficient to destroy the antigenic protein; and
cooling said heated latex to a lowered temperature for subsequent handling.

8. A pasteurization process as claimed in claim 7, wherein:
before the cold raw liquid latex from the balance tank is caused to flow through the heater, it is first caused to flow through a heat exchanger in counter flow relationship with previously heated latex, the cold raw latex being warmed and the heated latex being cooled in the heat exchanger.

9. A pasteurization process as claimed in claim 8, wherein:
a positive displacement timing pump draws product through the heat exchanger and pushes the product under pressure through the heater.

10. A pasteurization process as claimed in claim 9, wherein:
the warm latex leaving the heat exchanger is passed through a cooler to make the latex cold.
